(19) United States
(12) Patent Application Publication
(10) Pub. No.: US 2024/0238153 A1
(43) Pub. Date: Jul. 18, 2024

(54) HYBRID MASSAGE MODULE OF MASSAGE DEVICE

(71) Applicant: BODYFRIEND CO., LTD., Seoul (KR)

(72) Inventors: Ju Song HUR, Seoul (KR); Sung Chan CHOI, Seoul (KR)

(21) Appl. No.: 18/289,353

(22) PCT Filed: Dec. 19, 2022
(86) PCT No.: PCT/KR2022/020667

§ 371 Date: Nov. 2, 2023

(30) Foreign Application Priority Data
Dec. 17, 2021 (KR) 10-2021-0181472
Mar. 21, 2022 (KR) 10-2022-0034799

(51) Int. Cl. A61H 15/00

(52) U.S. Cl. CPC A61H 15/0078; A61H 2015/0035; A61H 2015/0071; A61H 2201/0149; A61H 2201/1215; A61H 2201/5007; A61H 2205/04; A61H 2205/081; A61H 2205/086

(57) ABSTRACT

The present disclosure relates to a hybrid massage module of a massage device. The hybrid massage module according to the present disclosure may include: a module base provided in a massage device; an actuator provided at the module base so as to provide power for at least one from among vibration, linear movement, rotational movement, and massage position adjustment for massaging of the body; a coupling bracket connected to the actuator so as to transmit power of the actuator; a unit bracket provided at the coupling bracket so as to be rotatable around a hinge shaft; an elastic member for elastically supporting the unit bracket with respect to the coupling bracket; a sample member rotatably provided at the unit bracket so as to apply acupressure to the body while rolling along body parts of the user; and a locking unit for locking or unlocking the unit bracket to or from the coupling bracket by means of a control signal applied from a control unit of the massage device.

### TECHNICAL FIELD

The present invention relates to a massage module included in a massage device, and more specifically, to a hybrid massage module of a massage device which performs a massage function by applying vibration or pressure to a user's body part using a roller-shaped or ball-shaped sample member.

### BACKGROUND ART

Recently, as the standard of living has improved and the population has aged, the number of people experiencing muscle paralysis or muscle pain due to a lack of exercise and stress is increased, and an interest in massage devices is also increased.

Therefore, massage devices having not only the simple massage functions but also various functions and high performance have emerged to meet user needs.

A chair-type massage device massages various parts of the body that come into direct contact with a chair, such as the neck, the back, the waist, the buttocks, the arms, the legs, and the feet, using mechanical and air-type sample members.

Typically, the chair-type massage device includes a massage module having roller-type sample members on the backrest. While the massage module moves up and down from the neck to the waist, the sample members vibrate, rotate, or oscillate in various directions to perform massage actions to rub and tap the body, thereby alleviating fatigue and performing functions such as muscle relaxation, spine alignment, and massage.

Such massage module of the massage device massages the body using the plurality of sample members while moving along the body parts, but if the sample members are fixed, they can cause pain by exerting excessive pressure onto the contours of the body part.

To address the problem, a unit bracket on which the sample member is mounted is rotatably connected to a coupling bracket, which is connected to the actuator of the massage module, around a hinge shaft, and the unit bracket and the coupling bracket are connected with an elastic member like a tension spring, such that the unit bracket can rotate elastically in the anteroposterior direction when the sample members perform massage while rolling along the curve of the body, thereby providing gentle pressure to the body part.

However, the conventional massage module has a disadvantage in that the massage device cannot provide sufficient pressure when stronger pressure is needed since the unit bracket always moves elastically.

### CITATION

### Patent Literature

Korean Patent No. 10-1730782 (granted on Apr. 20, 2017)
Korean Patent No. 10-2303155 (granted on Sep. 10, 2021)

### DISCLOSURE

### Technical Problem

Accordingly, the present invention has been made in view of the above-mentioned problems occurring in the related art, and it is an object of the present invention to provide a hybrid massage module for a massage device which can fix or release a unit bracket, on which a sample member is mounted, relative to a coupling bracket connected to an actuator, thereby applying strong pressure by fixing the position of the sample member or applying gentle pressure by elastically moving the sample member as occasion demands.

### Technical Solution

To accomplish the above-mentioned objects, according to the present invention, there is provided a hybrid massage module of a massage device including: a module base installed in the massage device; an actuator installed on the module base, and providing at least one of powers for vibration, linear motion, rotational motion, and position adjustment for body massage; a coupling bracket connected to the actuator to transmit the power of the actuator; a unit bracket installed on the coupling bracket to be rotatable around a hinge shaft; an elastic member supporting the unit bracket elastically relative to the coupling bracket; a sample member rotatably installed on the unit bracket, applying pressure to a user's body part while rolling; and a locking unit which, based on a control signal applied from the control unit of the massage device, fixes or releases the unit bracket relative to the coupling bracket.

According to one aspect of the present invention, the locking unit comprises: a locking protrusion formed to protrude from one surface of the unit bracket or the coupling bracket, a locking plate which is movably installed on the coupling bracket or the unit bracket and has a protrusion insertion hole into which the locking protrusion is inserted, and a locking actuator which is installed on the coupling bracket or the unit bracket to reciprocally move the locking plate toward the locking protrusion within a range of a predetermined distance by a control signal supplied from the control unit 50 of the massage device.

The locking actuator includes: a motor which rotates by a control signal applied from the control unit, and a cam which is axially coupled to the motor in a rotatable manner and of which the outer surface is in contact with the outer surface of the locking plate to push and move the locking plate toward the unit bracket according to rotational angles.

A wear-resistant material cover is provided on the surface of the locking plate which is in contact with the cam.

The hybrid massage module further includes a return spring which elastically supports the locking plate relative to the coupling bracket or the unit bracket.

A guide hole is formed in the coupling bracket or the unit bracket, and a guide pin is provided in the guide hole to guide the movement of the locking plate relative to the coupling bracket or the unit bracket due to one end portion of the guide pin which is coupled to the locking plate to connect the locking plate.

The locking unit comprises a locking pin which is installed on the coupling bracket or the unit bracket to be linearly movable and is inserted into a locking hole formed in the unit bracket or the coupling bracket, and a pin actuator which reciprocally moves the locking pin within a range of a predetermined distance according to a control signal supplied from the control unit.

The pin actuator is a solenoid-type actuator which generates an electric field by the control signal applied from the control unit to linearly move the locking pin within a range of a predetermined distance.

The pin actuator includes a motor which rotates by the control signal from the control unit, a rotary member which rotates by being shaft-coupled to the motor, a pin operating member which linearly reciprocates the locking pin according to the rotational angle of the rotary member, and a return spring which elastically supports the locking pin in a direction to separate the locking pin from the locking hole.

The pin operating member is a cam which is in close contact with one end of the locking pin and applies a pushing force to the locking pin according to the rotational angle to move the locking pin.

The pin operating member is a magnet which moves the locking pin by magnetic force.

The locking unit selectively fixes the unit bracket relative to the coupling bracket at a plurality of positions.

The hybrid massage module further includes a position detection sensor which detects the rotational position of the unit bracket relative to the coupling bracket, wherein the control unit of the massage device applies a control signal to the locking unit according to the detected rotational position of the unit bracket to fix or release the unit bracket relative to the coupling bracket.

When the module base moves to a specific location of the massage device where no load from the user's body is applied to the sample member, the control unit of the massage device applies the control signal to the locking unit to fix or release the unit bracket relative to the coupling bracket.

### Advantageous Effect

According to the present invention, when the unit bracket is in a specific state relative to the coupling bracket, for instance, when the unit bracket is in an initial state that no load from the user is applied to the unit bracket and only the elastic force of the elastic member is applied to the unit bracket, the control signal can be applied to the locking unit from the control unit, such that the unit bracket can be fixed to the coupling bracket. In the above state, when the massage device massages the user's body while moving the massage module, since the unit bracket is fixed to the coupling bracket, strong pressure can be provided.

Contrarily, when the locking unit releases the fixed state between the unit bracket and the coupling bracket, the unit bracket moves elastically relative to the coupling bracket, thereby offering a soft pressure effect.

That is, the massage module of the present invention, using the locking unit, can easily convert into a structure of elastically moving the unit bracket relative to the coupling bracket and a structure of fixing the unit bracket relative to the coupling bracket, thereby easily adjusting pressure.

### DESCRIPTION OF DRAWINGS

FIG. 1 is a view for depicting a massage device according to an embodiment of the present invention.

FIG. 2 is a view illustrating a main frame according to an embodiment of the present invention.

FIG. 3 is a view illustrating the massage device according to an embodiment of the present invention.

FIG. 4 is a view illustrating an external device capable of communicating with the massage device according to an embodiment of the present invention.

FIG. 5 is a perspective view of a massage module according to an embodiment of the present invention.

FIG. 6 is a side view of the massage module according to an embodiment of the present invention.

FIG. 7 is a view illustrating a massage action by the massage module according to an embodiment of the present invention.

FIGS. 8A and 8B are right and left side views respectively, of a locking unit of the massage module according to a first embodiment of the present invention, wherein FIG. 8A illustrates a released state of the locking unit, and FIG. 8B illustrates a fixed state of the locking unit.

FIGS. 9A and 9B are cross-sectional views of the locking unit of the massage module according to the first embodiment of the present invention, wherein FIG. 9A illustrates the released state of the locking unit, and FIG. 9B illustrates the fixed state of the locking unit.

FIGS. 10A and 10B are perspective views of the locking unit of the massage module according to the first embodiment of the present invention, wherein FIG. 9A illustrates the released state of the locking unit, and FIG. 9B illustrates the fixed state of the locking unit.

FIG. 11 is a perspective view illustrating a locking unit of the massage module according to a second embodiment of the present invention.

FIG. 12 is a cross-sectional view of the locking unit illustrated in FIG. 11.

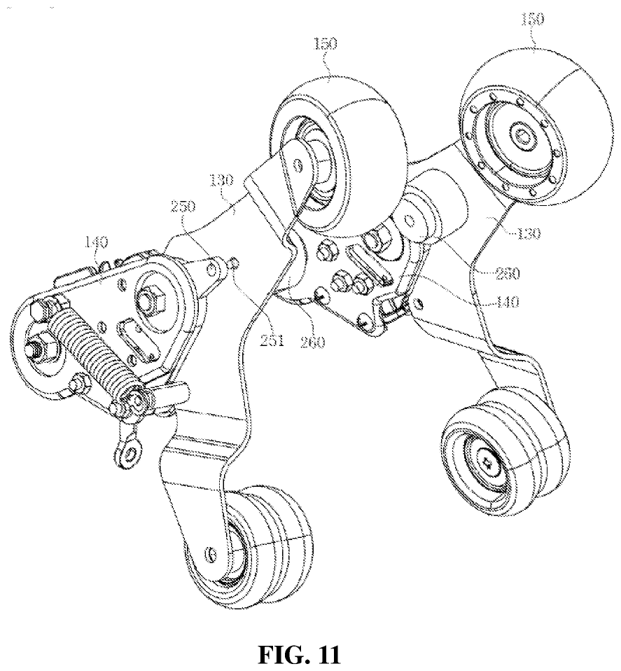

FIG. 13 is a cross-sectional view illustrating a locking unit of the massage module according to a third embodiment of the present invention.

### BEST MODE

The present invention relates to a hybrid massage module of a massage device including: a module base installed in the massage device; an actuator installed on the module base, and providing at least one of powers for vibration, linear motion, rotational motion, and position adjustment for body massage; a coupling bracket connected to the actuator to transmit the power of the actuator; a unit bracket installed on the coupling bracket to be rotatable around a hinge shaft; an elastic member supporting the unit bracket elastically relative to the coupling bracket; a sample member rotatably installed on the unit bracket, applying pressure to a user's body part while rolling; and a locking unit which, based on a control signal applied from the control unit of the massage device, fixes or releases the unit bracket relative to the coupling bracket.

### MODE FOR INVENTION

Advantages and features of the present invention and methods accomplishing the advantages and features will become apparent from the following detailed description of exemplary embodiments with reference to the accompanying drawings. However, the present invention is not limited to exemplary embodiment disclosed herein but will be implemented in various forms. The exemplary embodiments are provided so that the present invention is completely disclosed, and a person of ordinary skilled in the art can fully understand the scope of the present invention.

Terms used herein will be briefly described, and the disclosed embodiments will be described in detail.

The terms including descriptive or technical terms which are used herein should be construed as having meanings that are obvious to one of ordinary skill in the art. However, the terms may have different meanings according to an intention of one of ordinary skill in the art, precedent cases, or the appearance of new technologies. Also, some terms may be arbitrarily selected by the applicant, and in this case, the meaning of the selected terms will be described in detail in the detailed description of the invention. Thus, the terms used herein have to be defined based on the meaning of the terms together with the description throughout the specification.

The singular forms of the components may be understood into the plural forms unless otherwise specifically stated in the context. Furthermore, the plural forms may include singular forms unless otherwise specifically stated in the context.

In the entire specification of the present invention, when a certain part “includes” a certain component, other components are not excluded unless explicitly described otherwise, and other components may in fact be included.

The term, “unit”, used in the present invention means a software element or a hardware element, and the “unit” performs some roles. However, the term, “unit”, is not limited to software or hardware. The “unit” may be configured in an addressable storage medium or may be configured to play one or more processors.

Therefore, as an example, a “unit” includes elements, such as software elements, object-oriented software elements, class elements, and task elements, processes, functions, attributes, procedures, subroutines, segments of program codes, drivers, firmware, microcode, circuits, data, databases, data structures, tables, arrays, and variables. Functions provided within the elements and “units” may be combined with a smaller number of elements and “units” or may be further divided into additional elements and “units”.

According to an embodiment of the present invention, the “unit” may be implemented as a processor and a memory. The term “processor” should be interpreted broadly to encompass a general-purpose processor, a central processing unit (CPU), a microprocessor, a digital signal processor (DSP), a controller, a microcontroller, a state machine, and the like. In some environments, a “processor” may refer to an application specific integrated circuit (ASIC), a programmable logic device (PLD), a field programmable gate array (FPGA), or the like. The term “processor” may refer to a combination of processing devices, such as a combination of a DSP genome and a microprocessor, a combination of a plurality of microprocessors, a combination of one or more microprocessors in combination with a DSP couple core, or a combination of any other such configurations.

The term “memory” should be interpreted broadly to include any electronic component capable of storing electronic information. The term memory may refer to various types of processor-readable media such as random access memory (RAM), read-only memory (ROM), non-volatile random access memory (NVRAM), programmable read-only memory (PROM), erase-programmable read-only memory (EPROM ACL), electrically erasable PROM (EEPROM), flash memory, magnetic or optical data storage, registers, and the like. Memory is referred to as being in electronic communication with the processor if the processor can read information from, and/or write information to, the memory. The memory integrated in the processor is in electronic communication with the processor.

In the present specification, an actuator refers to a configuration capable of providing a driving force. For example, the actuator may include a motor, a linear motor, an electronic motor, a DC motor, an AC motor, a linear actuator, an electric actuator, and the like, but is not limited thereto.

In the present specification, according to an embodiment, a massage device may refer to a massage device including a body massage part and a leg massage part. In addition, according to another embodiment, a body massage part 2100 and a leg massage part 2300 may be provided as separate devices (for example, a body massage device and a leg massage device), and the massage device may refer to a body massage device or a leg massage device.

Hereinafter, embodiments of the present invention will be described in detail with reference to the accompanying drawings so as to be easily carried out by a person skilled in the art to which the present invention pertains. In addition, in order to clearly describe the present invention, portions irrelevant to the description will be omitted.

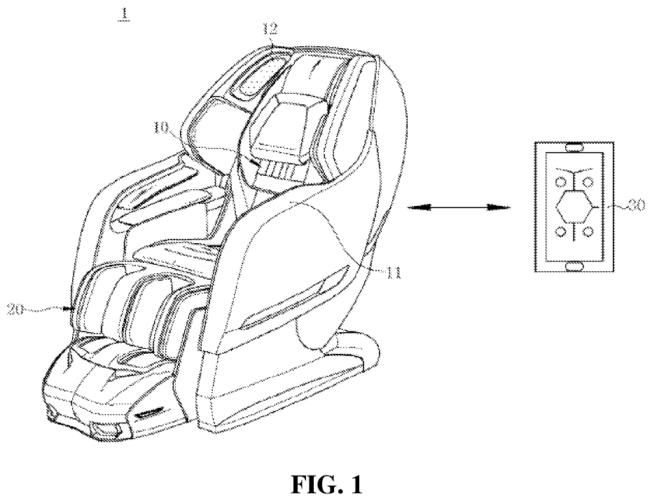

FIGS. 1 to 4 are drawings illustrating a chair-type massage device according to an embodiment of the present invention.

As illustrated in FIG. 1, the massage device 1 according to an embodiment of the present invention may include a body massage part 10 which has a region for accommodating at least a portion of a user's body and massages the user's torso, and a leg massage part 20 which massages the user's legs.

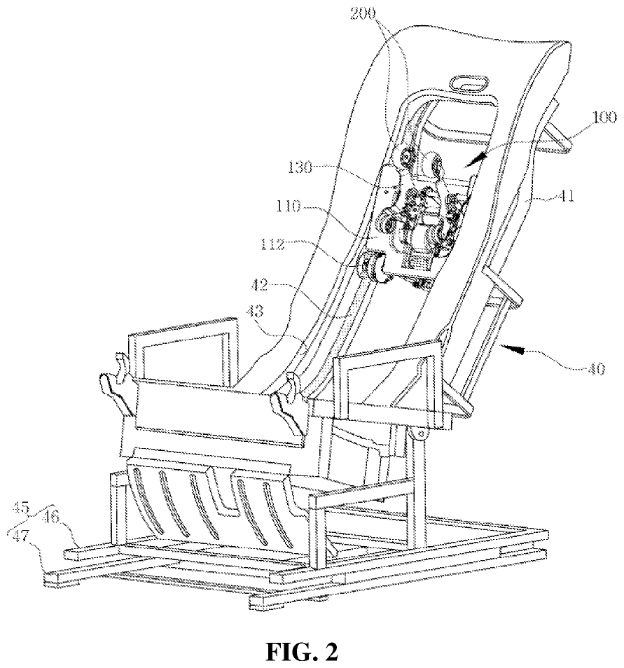

The body massage part 10 can provide a massage to at least a portion of the user's body. The body massage part 10 can include a massage module 100 for providing a massage function to at least a portion of the user's body, an audio output module 12 for providing audio output in any form to the user, a main frame 40 (see FIG. 2) which forms a framework of the body massage part 10, and an input part (not illustrated) for receiving any form of input from the user.

The components included in the body massage part 10 are just exemplary embodiments, and the body massage part 10 may include other various components.

Additionally, the shape and the structure of the massage device 1 illustrated in FIG. 1 are just examples, and various forms of massage device 1 can be included within the scope of the present invention without departing from the scope of the present invention defined by the claims of the present invention.

The body massage part 10 can form a space of any shape to accommodate the user. The body massage part 10 may have a space with the shape corresponding to the shape of the body of the user. For example, as illustrated in FIG. 1, the body massage part 10 can be realized as a seat type that can accommodate the whole body of the user or a portion of the body of the user.

A portion of the body massage part 10 which is in contact with the ground may include any material or component (for example, a non-slip pad) for increasing frictional force, and may include wheels for enhancing mobility of the massage device 1.

At least a portion of the body massage part 10 can slide. For instance, when the body massage part 10 starts a massage, at least a portion of the body massage part 10 can slide forward. Additionally, the body massage part 10 can tilt backwards. As a result, the body massage part 10 can provide a massage while tilted backwards.

According to an embodiment of the present invention, the massage device 1 may include at least one air cell (not illustrated). The air cell can be located in an area corresponding to the user's shoulders, an area corresponding to the pelvis, the arm massage part, and the leg massage part 20, but is not limited thereto, and may be placed in various parts of the massage device 1.

The massage device 1 may include an air supply unit, which can inflate the air cell by supplying air to the air cell. The air supply unit may be located inside the body massage part 10 or may be located in the leg massage part 20. In addition, the air supply unit can be located outside the massage device 1.

The leg massage part 20 can provide the user with a leg massage function. For instance, the leg massage part 20 can include a calf massage module which massages the user's calves and/or a foot massage module which massages the user's foot.

The leg massage part 20 can be adjustable in length according to the user's body characteristics. For example, when the user who is tall uses the massage device 1, it is necessary to extend the length of the leg massage part 20 since the user's calves are long.

Moreover, when the user who is short uses the massage device 1, it is necessary to reduce the length of the leg massage part 20 since the user's calves are short. Accordingly, the leg massage part 20 can provide a leg massage tailored to the user's height.

The massage module 100 (see FIG. 2) may be installed inside the body massage part 10 to provide any type of mechanical stimulation to the user accommodated in the body massage part 10. The massage module 100 can move along the main frame 40 (see FIG. 2) installed inside the body massage part 10.

For instance, a rack gear may be provided on the main frame 40 of the body massage part 10, and the massage module 100 can provide mechanical stimulation to various parts of the body of the user while moving along the rack gear. The massage module 100 can include a ball massage part or a roller massage part, but is not limited thereto.

The main frame 40 can form a frame of the internal configuration of the body massage part 10, and may be made of metal or plastic. For example, the main frame 40 may be made of iron, alloy, steel, etc., but is not limited thereto, and can be realized with various hard materials.

According to an embodiment of the present invention, the massage device 1 can include the audio output module 12. The audio output module 12 may be provided in various locations. For example, the audio output module 12 may include multiple output parts such as a top audio output part placed on the top of the seat part in contact with the user, a front audio output part coupled to the front end of the arm massage part on both sides of the seat part, and/or a rear audio output part coupled to the rear end of the arm massage part, but is not limited thereto. In this case, the audio output module 12 can provide stereophonic sound such as 5.1 channels, but is not limited thereto.

According to an embodiment of the present invention, the user can control the massage device 1 using a massage device control device 30. The massage device control device 30 can be connected to the massage device 1 through wired communication and/or wireless communication.

The massage device control device 30 may include at least one user device (personal device), such as a remote controller, a cellular phone, and a PDA (Personal Digital Assistant), but is not limited thereto, and may include various electronic devices that can be connected to the massage device 1 through wired or wireless communication.

FIG. 2 is a view for depicting a main frame according to an embodiment of the present invention.

According to an embodiment of the present invention, the main frame 40 may include an upper frame 41, on which a massage module 100 is equipped, and a base frame 45 that supports the upper frame 41.

A rack gear 42 may be provided on at least a portion of the upper frame 41. The rack gear 42 is a member which guides the vertical movement of the massage module 100. The rack gears 42 may be provided on both sides of the upper frame 41 to face each other. A plurality of gear teeth with which module movement pinion gears 112 installed at both sides of the massage module 100 mesh are continuously arranged on the rack gears 42 in the longitudinal direction of the upper frame 41, thereby providing drive force for movement of the massage module 100. The massage module 100 may move along the rack gear 42.

In FIG. 2, the rack gears 42 are formed in the vertical direction, but are not limited thereto. The rack gear 42 may include a front-rear direction rack gear and a vertical rack gear. The front-rear direction in the present invention means the direction heading towards the user from the massage module 100 or heading towards the massage module 100 from the user, and may mean the Z-axis direction. Furthermore, the upward direction and the downward direction in the present invention may mean upward and downward directions guided by the rack gears 42. That is, the upper direction and the downward direction may not be perpendicular to the ground.

The massage module 100 may include the module movement pinion gears 112 that mesh with the rack gears 42. More specifically, the massage module 100 may include gears that respectively mesh with a front-rear direction rack gear and a vertical rack gear. When the module movement pinion gears 112 rotate by an actuator provided on a module base 110 of the massage module 100, the massage module 100 can move forward, backward, upward, or downward along the rack gears 42.

As the massage module 100 moves forward, the intensity of the massage may increase. Additionally, as the massage module 100 moves backward, the intensity of the massage may decrease.

The rack gear 42 may be made of metal or plastic materials. For example, the rack gear 42 may be made of iron, steel, alloy, reinforced plastic, melamine resin, phenolic resin, etc., but is not limited thereto.

The upper frame 41 may be realized in various shapes. For instance, the upper frame 41 may be classified into an S-frame, an L-frame, an S&L frame, a double S&L frame according to shapes, but is not limited thereto.

The S-frame refers to a frame where at least a portion of the upper frame 41 includes a curved shape like “S”. The L-frame means a frame that includes a bent shape like “L” in at least a portion of the upper frame 41. The S&L frame means a frame including an “S”-shaped curved form and an “L”-shaped bent form. The double S&L frame means a frame including an “L”-shaped bent form and two “S”-shaped curved forms.

The base frame 45 means a part which supports the upper frame 41 of the main frame 40 and is in contact with the ground.

The base frame 45 may include an upper base frame 46 and a lower base frame 47. The upper base frame 46 may support the upper frame 41, and the lower base frame 47 may come into contact with the ground. Additionally, the upper base frame 46 can be positioned to be in contact with the lower base frame 47.

According to an embodiment of the present invention, the upper base frame 46 can move along the lower base frame 47. For instance, the upper base frame 46 can slide forwards or backwards along the lower base frame 47. In this case, the upper frame 41 is connected to the upper base frame 46, can move according to the movement of the upper base frame 46.

For example, when the upper base frame 46 moves forward, the upper frame 41 can also move forward, and when the upper base frame 46 moves backward, the upper frame 41 can also move backward. As a result, the sliding movement of the body massage part 10 can be permitted.

In detail, to allow the movement of the upper base frame 46, a moving wheel may be provided on the underside of the upper base frame 46. Additionally, a guide member, which can guide the moving wheel, may be provided on the top of the lower base frame 47. The moving wheel provided on the upper base frame 46 can move along the guide member provided on the lower base frame 47, allowing for the forward or backward movement of the upper base frame 46.

According to another embodiment of the present invention, the massage device 1 may not provide a sliding function, and in this case, the base frame 45 may not be separated into upper and lower frames.

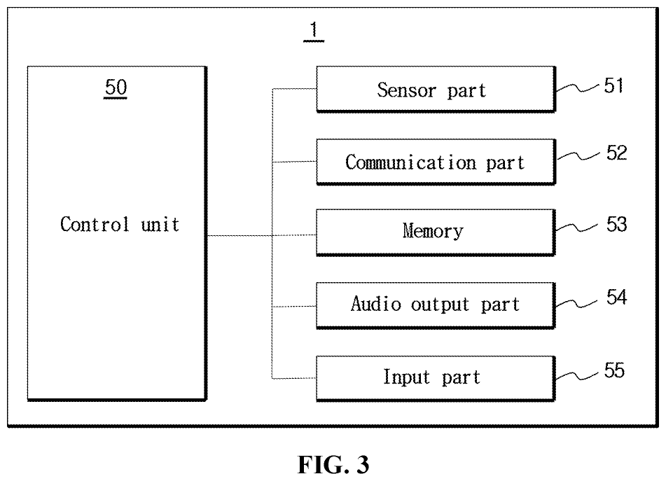

FIG. 3 is a view illustrating a configuration for control of a massage device according to an embodiment of the present invention.

The massage device 1 may include at least one among a control unit 50, a sensor part 51, a communication part 52, memory 53, an audio output part 54, and an input part 55. The control unit 50 may include at least one processor and memory. The at least one processor can execute instructions stored in memory.

The control unit 50 can control the massage device 1. The control unit 50 may include one processor, or a plurality of processors. When the control unit 50 includes the plurality of processors, at least some of the plurality of processors can be located at physically distanced locations. In addition, the massage device 1 is not limited thereto, and can be realized in various ways.

According to an embodiment of the present invention, the control unit 50 may control the operation of the massage device 1. For instance, the massage device 1 may include a plurality of actuators, and the control unit 50 can control the operation of the massage device 1 by controlling the operation of the plurality of actuators.

For example, the massage device 1 may include at least one among a driving unit that moves the armrest frame support, at least one actuator included in the massage module 100, a back angle actuator, a leg angle actuator, a foot massage actuator, a leg length adjustment actuator, and a sliding actuator.

The back angle actuator is an actuator that adjusts the angle of a part of the massage device 1 contacting with the user's back, and the back angle of the massage device 1 can be adjusted by the operation of the back angle actuator. The leg angle actuator is an actuator to adjust the angle of the leg massage part 20 of the massage device 1, and the angle between the leg massage part 20 and the body massage part 10 can be adjusted by the operation of the leg angle actuator. The foot massage actuator represents an actuator that operates the foot massage module included in the leg massage part 20. For instance, the control unit 50 can provide a foot massage to the user using the foot massage actuator. The leg length adjustment actuator represents an actuator that adjusts the length of the leg massage part 20. For example, the control unit 50 can adjust the length of the leg massage part 20 to fit the user using the leg length adjustment actuator, and as a result, the user can receive a massage suited to the body shape.

At least one actuator included in the massage module 100 may be an actuator of various kinds such as a moving actuator, a forward-backward actuator, and a massage actuator.

The moving actuator is an actuator that enables the up and down movement of the massage module 100, which can move the massage module 100 in at least one of the upward direction and the downward direction of the massage device 1 along the main frame 40. The massage module 100 can move along the rack gear due to the operation of the moving actuator. The forward-backward actuator can advance (or tilt) the massage module 100 in at least one of the forward and backward directions. The massage module 100 can tilt in at least one of the forward and backward directions through the forward-backward actuator. The massage actuator can move the massage module 100 in various ways to provide various massage actions to the user.

The control unit 50 can control the operation of the massage device 1 by controlling the detailed configuration of the massage device 1.

The control unit 50 can provide various massage actions by operating at least one actuator included in the massage device 1. For example, by operating at least one actuator included in the massage module 100, the control unit 50 can provide a tapping massage, a kneading massage, and so on, and is not limited to providing various massage actions.

The memory 53 may be included in the control unit 50 or can be located outside the control unit 50. The memory 53 can store various pieces of information related to the massage device 1. For instance, the memory 53 can include massage control information, user information, and is not limited thereto. User information may contain various kinds of information associated with the user, such as personal authentication information, the user's biometric information (for example, age, height, weight, blood pressure, body composition, pulse, electrocardiogram, etc.) and the like.

The memory 53 can be realized through a non-volatile storage medium, which can continuously store arbitrary data. For example, the memory 53 may include storage devices based on a disk, an optical disk, a magneto-optical storage device, a flash memory and/or a battery-backed memory, and is not limited thereto.

The memory 53 is a primary storage device directly accessed by the processor, such as a random access memory (RAM) like a dynamic random access memory (DRAM) and a static random access memory (SRAM), and means a volatile storage device in which stored information is instantly erased when power is turned off, but it is not limited thereto. The memory 53 can be operated by the control unit 50.

The massage device 1 may include a sensor unit 51. The sensor unit 51 can acquire a variety of information using at least one sensor. The sensor unit 51 can be equipped with sensors using measurement means such as pressure, potential, and optics. For example, the sensor unit may include a pressure sensor, an infrared sensor, an LED sensor, a touch sensor, an electrode sensor, an air pressure measurement sensor, and is not limited thereto.

Moreover, the sensor unit 51 may include a biometric information acquisition sensor. The biometric information acquisition sensor can acquire at least one of fingerprint information, face information, voice information, iris information, weight information, blood pressure information, heartbeat (or heart rate) information, electrocardiogram information, body composition information, and is not limited thereto, and may a variety of biometric information. The massage device 1 can provide a customized massage based on the information acquired through the sensors.

The massage device 1 can detect a contact area and/or contact position with the user through the sensors. Moreover, the massage device 1 can provide a customized massage based on the information acquired through the sensors.

The communication unit 52 can receive a signal transmitted from an external device or transmit a signal about the massage device 1 to the external device.

For example, the control unit 50 can process the signal received through the communication unit 52 to acquire a result signal, and can transmit the result signal to the communication unit 52. The communication unit 52 can transmit (or output) the result signal to the external device.

The control unit 50 can acquire information on various components included in the massage device 1 (for instance, information on the massage module 100, information on the arm massage part, etc.), and can transmit the information to the communication unit 52. The communication unit 52 can transmit the information regarding the massage device 1 to the external device.

The communication unit 52 can communicate with an internal module of the massage device 1, an external massage device and/or a user terminal via any type of network. The communication unit can include a wired/wireless connection module for network access. For wireless connection technology, for example, there are WLAN (Wireless LAN) (Wi-Fi), Wibro (Wireless broadband), Wimax (World Interoperability for Microwave Access), HSDPA (High-Speed Downlink Packet Access), and the like. For wired connection technology, for instance, there are XDSL (Digital Subscriber Line), FTTH (Fibers to the home), PLC (Power Line Communication), and the like. In addition, the network connection unit can include a short-range communication module, which allows data transmission and reception with any device/terminal located in close range. For short-range communication technology, there are Bluetooth, RFID (Radio Frequency Identification), IrDA (infrared Data Association), UWB (Ultra-Wideband), ZigBee, and the like, and the communication technologies are not limited thereto.

The massage device 1 may further include an input part 55 and/or output part. The massage device 1 can receive input from the user by using the input part 55. The massage device 1 can output the processed results of the control unit 50 by using the output part.

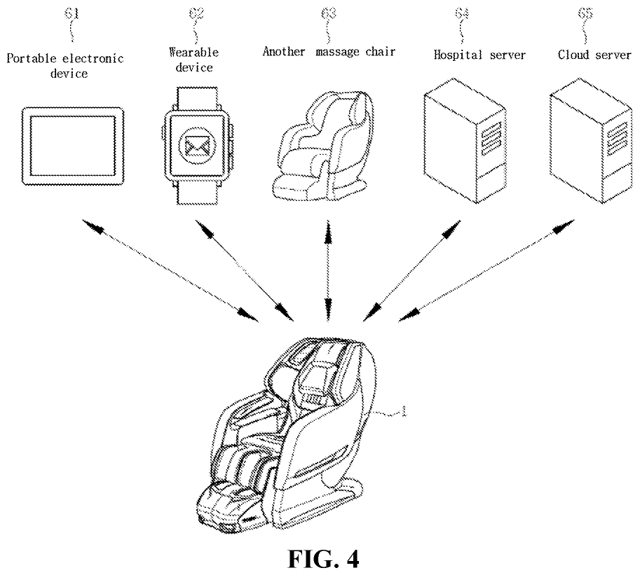

Specifically, the input part can receive commands related to the operation control of the massage device 1 from the user, and the input part may be realized in various forms. For example, the input part can be equipped in the body massage part 10, and can be equipped in the leg massage part 20, but is not limited thereto. In addition, the input part may include a massage device control device 30, or various external devices to be described in FIG. 4.

The massage device 1 can acquire various commands from the user through the input part. For example, the massage device 1 can receive any command for selection of the massage module, selection of massage type, selection of massage intensity, selection of massage time, selection of the massage area, selection related to the position and operation of the body massage part 10, on-off selection for the power of the massage device 1, selection regarding the operation of the heat function, selection related to music playback, and more, but it is not limited thereto.

The massage device 1 can provide an interface for selecting the massage mode through the input part 55. For example, the input part and/or output part can include a massage device control device 30. Various modes of medical massage related to body improvement can be listed through the massage device control device 30.

The medical massage mode may include at least one among a focus mode, a meditation mode, a recovery mode, a stretching mode, a sleep mode, a vitality mode, a golf mode, a hip up mode, a student mode, a zero gravity mode, and a growth mode.

According to another embodiment of the present invention, the input part 55 can be equipped with buttons in the form of a hot key and/or selection buttons to execute direction selection, cancellation, and input, depending on pre-set user settings or its own pre-set functions.

The input part 55 can be realized as a touchscreen, a keypad, a dome switch, a touch pad (pressure/static), a jog wheel, a jog switch, and others, but is not limited thereto. Moreover, the input part 55 can acquire commands through the user's speech based on voice recognition technology.

The output part may include a display for displaying the operating situation of the massage device 1 or the current status of the user. In this case, the display may include at least one of a liquid crystal display (LCD), a thin film transistor-liquid crystal display (TFT LCD), an organic light emitting diode (OLED), a flexible display, a 3D display, and the like, but is not limited thereto.

The output part may include an audio output part 54. The audio output part 54 of FIG. 3 may include the audio output module 12 of FIG. 1. The audio output part 54 can provide any type of audio output to the user. For example, the audio output part 54 can provide brain stimulation to the user by outputting music and/or binaural beats optimized for the massage pattern provided by the massage device 1. The audio output part 54 can output an acoustic signal received through a network (not illustrated) or stored in an internal/external storage medium (not illustrated). For instance, the audio output part 54 can output music controlled by the user's terminal through a network connection (e.g., a Bluetooth connection) with the user's terminal. In addition, the audio output part 54 can output any type of acoustic signal related to the operation of the massage device 1.

A person of ordinary skill in the technical field to which the present invention belongs would know well that the present invention can be realized by being combined with other program modules and/or by a combination of hardware and software. For example, the present invention can be realized by a computer-readable medium.

A medium accessible by a computer can be any computer-readable medium, and such a computer-readable medium includes volatile and non-volatile media, transitory and non-transitory media, and removable and non-removable media. As an example, without limitation, a computer-readable medium can include a computer-readable storage medium and a computer-readable transmission medium.

The computer-readable storage medium includes volatile and non-volatile, transitory and non-transitory, removable and non-removable media realized by any method or technology for storing information such as computer-readable instructions, data structures, program modules, or other data. The computer-readable storage medium includes RAMs, ROMs, EEPROMs, flash memories or other memory technology, CD-ROMs, digital video disks (DVD) or other optical disk storage devices, magnetic cassettes, magnetic tape, magnetic disk storage devices or other magnetic storage devices, or any other medium that can be accessed by a computer and used to store desired information, but is not limited thereto.

FIG. 4 is a view illustrating an external device that can communicate with a massage device according to an embodiment of the present invention.

The massage device 1 can transmit and receive various data by wire or wirelessly with the external device.

The external device may include a portable electronic device 61 such as an AI speaker, a tablet, or a smartphone. The portable electronic device 61 may be dedicated to the massage device 1 or may be a general-purpose portable electronic device. In addition, the external device may include a wearable device 62 such as a smartwatch or a smart band. The external device may include not the massage device 1 that the user is not currently using but another massage device 63 that the user is not currently using. The external device may include a hospital server 64. The external device may include a personal health record (PHR) server. Additionally, the external device may include a cloud server 65. The external device may include a medical measurement device such as an electronic scale, a blood glucose meter, or a blood pressure meter.

While examples of external devices have been described in the present invention, it should be understood that all electronic devices capable of acquiring user's biometric information can be included as external devices.

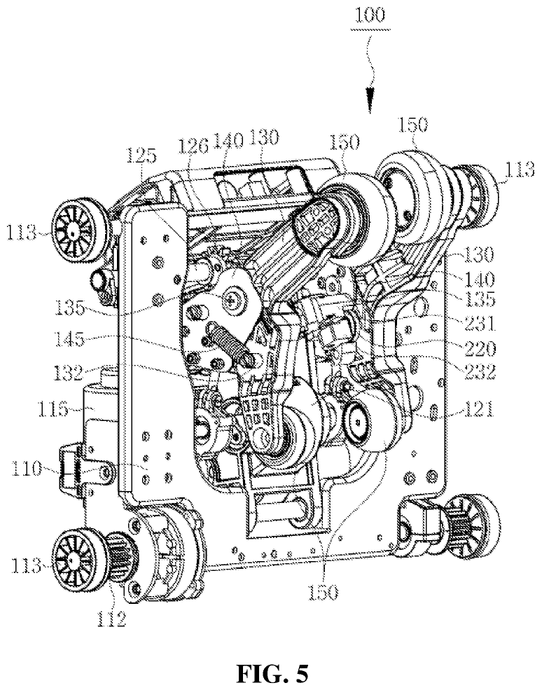

FIGS. 5 to 7 illustrate the massage module 100 according to an embodiment of the present invention.

The massage module 100 includes a module base 110 which moves along the upper frame 41 of the massage device 1 (see FIG. 2), an actuator which is installed on the module base 110 to provide at least one of powers for vibration, linear motion, rotational motion, or massage position adjustment for body massage, two unit brackets 130 which are connected to the actuator for movement, and a plurality of sample members 150 rotatably installed at the top and bottom of each unit bracket 130.

The module base 110 is formed in a roughly ‘U’-shaped flat plate with an open center. A module movement pinion gear 112 which meshes with the module movement rack gear 42 (see FIG. 2) installed on the upper frame 42 and moves along the module movement rack gear 42 is installed on both sides of the bottom of the module base. Wheels 113 which roll along the rails 43 (see FIG. 2) installed on both sides of the module movement rack gear 42 of the upper frame 41 (see FIG. 2) in parallel may be provide on the outer surface of the module movement pinion gear 42. As described above, the module movement pinion gear 112 rotates by receiving rotational force by the module movement actuator 115 installed at the rear of the module base 110 and rolls along the module movement rack gear 42, so that the massage module 100 is moved to a desired position along the upper frame 41.

On both sides of the module base 110, two unit brackets 130 are connected to the actuators for massage and position adjustment, and move in any direction by receiving power for body massage to cause linear and/or rotational movement in the anteroposterior direction and/or in the right-and-left direction of the sample members 150. Actuators formed on the module base 110 can include a massage actuator which produces linear and rotational movements and vibrations in the vertical direction, in the anteroposterior direction, and in the left-right direction of the sample members 150 to massage the body, a module movement actuator 115 which rotates the module movement pinion gear 112 to cause movement of the module base 110, and a moving actuator which moves the sample members 150 within a range of a predetermined distance in the anteroposterior direction (Z-axis direction) of the module base 110 to advance or retract the position of the sample members 150.

The massage actuator may include a kneading motor 121, a tapping motor (not illustrated), and a power transmission mechanism for transmitting power of the kneading motor 121 and the tapping motor to the unit bracket 130. The power transmission mechanism can be configured by suitably combining components such as cams, gears, pulleys and timing belts, and link mechanisms. Since the massage actuator can be configured by applying the same or similar configuration of the known actuator configured in a general chair-type massage device, detailed configuration and description of the massage actuator will be omitted.

The unit bracket 130 has a roughly ‘V’ shape, and can be made of metal or plastic material. The unit bracket 130 is connected to the massage actuator through a coupling bracket 140 to receive power and move in a predetermined direction. The middle part of the unit bracket 130 is rotatably connected to the coupling bracket 140 via a hinge shaft 135, and the lower part of the hinge shaft 135 is elastically connected to the coupling bracket 140 through an elastic member 145. Accordingly, the unit bracket flexibly varies the anteroposterior direction position of the sample member 150 of the upper portion and the sample member 150 of the lower portion while elastically rotating in the anteroposterior direction around the hinge shaft 135 along the curvature of the user's back, thereby performing a massage.

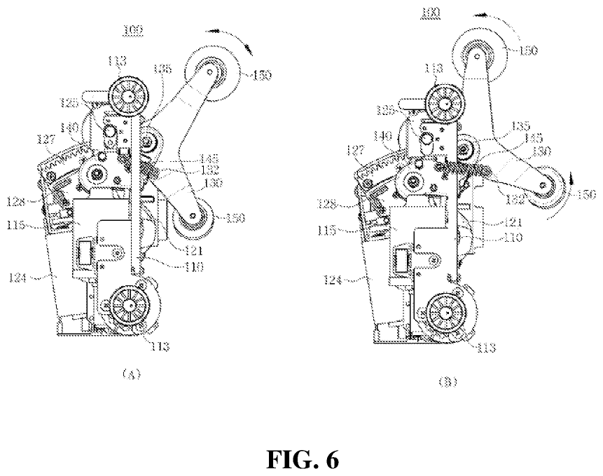

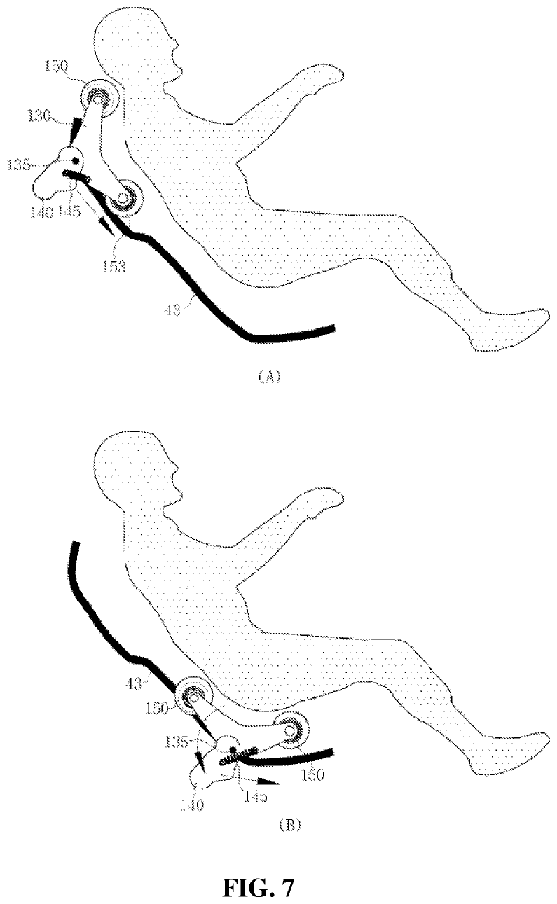

A spring connection pin 132 for connecting the elastic member 145 is provided at the bottom of the unit bracket 130. The elastic member 145 may be a tension coil spring which provides an elastic force to pull the lower portion of the unit bracket 130 backward. Therefore, as illustrated in FIG. 6(A), in a state in which the sample members 150 and unit bracket 130 are not subjected to a load by the user's body, the upper portion of the unit bracket 130 protrudes forward and the lower portion is pulled backward. As illustrated in FIG. 6(B), when the massage module 100 moves along the user's body part (see FIG. 7) and the sample members 150 and unit bracket 130 are subjected to a load by the user's body, the unit bracket 130 rotates elastically around the hinge shaft 135, so that the positions of the sample members 150 are flexibly changed to perform a massage.

Meanwhile, when the massage is performed by moving the module base 110 vertically while the positions of the sample members 150 remain fixed, it may not provide appropriate pressure along the curvature of the user's body part. Accordingly, when adjusting the anteroposterior direction position (depth) of the sample members 150 according to the position of the user's body part, the pressure applied to the body is adjusted, thereby effectively performing the massage. To adjust the depth of the sample members 150, the module base 110 may include a position adjustment motor 124, a shaft 125 for simultaneously transmitting the power from the position adjustment motor 124 to the two unit brackets 130, two position adjustment pinion gears 126 which are connected to the shaft 125 to be rotatable, and a position adjustment rack gear 127 which is installed at the top of an operating frame 128 connected to one side of the coupling bracket 140 and meshes with the position adjustment pinion gears 126. The position adjustment rack gear 127 is coupled to one side of the coupling bracket 140 to which the unit bracket 130 is connected.

Therefore, when the position adjustment motor 124 operates and the shaft 125 rotates, the position adjustment rack gear 127 and operating frame 128 that mesh with the position adjustment pinion gears 126 move a predetermined distance forward or backward, so that the coupling bracket 140 and unit bracket 130 reciprocally move a predetermined distance, thereby adjusting the anteroposterior direction position (depth) of the sample members 150.

The sample members 150 press the user's body part while being in contact with the user's body part, are in the form of a roller or a ball made of a resin material with elasticity, such as rubber or silicone, made of hard plastic or ceramics, or made of minerals like jade or germanium, and are rotatably installed at the top and bottom of each unit bracket 130. In this embodiment, there are two sample members 150 provided at the top and bottom of each unit bracket 130, but alternatively, three or more sample members 150 can be arranged vertically on the unit bracket 130. The sample member 150 can have a roller or ball shape, but it can also have a form equipped with protrusions or other auxiliary rollers or balls around the roller, a drum shape, or other various forms, and the sample member 150 installed at the top and the sample member 150 installed at the bottom of the unit bracket 130 can have different shapes or sizes.

As illustrated in FIGS. 6 and 7, the module movement pinion gear 112 and the wheel 113 are rotated by the module movement actuator 115, and the massage module 100 performs a massage by the sample members 150 while moving to a desired position along the frame and the rail 43 of the massage device 1. During the above process, the sample members 150 of the massage module 100 perform a massage while rolling along the curvature of the body. Since the unit bracket 130 rotates while being elastically supported by the elastic member 145, the massage device can provide gentle pressure force to the back and the waist of the body.

However, even when the user requires strong pressure at specific body parts, such as the shoulders or the waist area, if the unit bracket 130 continuously moves, the unit bracket cannot provide a desired pressure level.

Therefore, when the unit bracket 130 assumes a particular position relative to the coupling bracket 140, for example, as illustrated in FIG. 6(A), a locking unit is configured to lock the unit bracket 130 relative to the coupling bracket 140 in the initial state (unloaded state). Accordingly, when strong pressure is required at a specific body part, the unit bracket 130 may be fixed relative to the coupling bracket 140. That is, the massage module 100 is realized as a hybrid module that can conveniently convert into a structure of elastically moving the unit bracket 130 relative to the coupling bracket 140 and a structure of fixing the unit bracket 130 relative to the coupling bracket 140 by using a locking unit, thereby easily adjusting pressure.

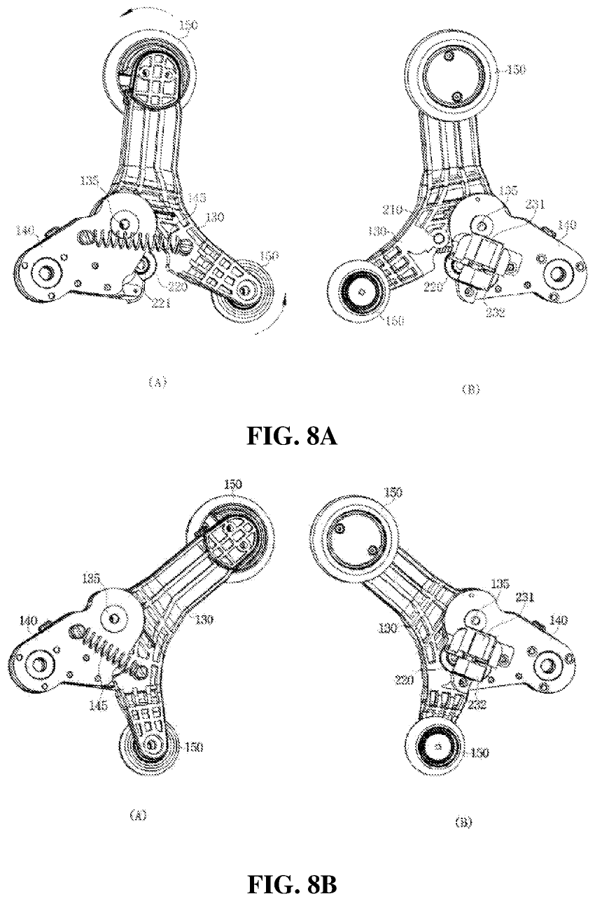

FIGS. 8 to 10 illustrate a first embodiment of the locking unit. The locking unit according to the first embodiment includes a locking protrusion 210 formed to protrude from one surface of the unit bracket 130, a locking plate 220 which is movably installed on the coupling bracket 140 and has a protrusion insertion hole 221 into which the locking protrusion 210 is inserted, and a locking actuator which is installed on the coupling bracket 140 to reciprocally move the locking plate 220 toward the locking protrusion 210 within a range of a predetermined distance by a control signal supplied from the control unit 50 of the massage device 1 (see FIG. 3).

The locking actuator includes a motor 231 which is installed on the coupling bracket 140 and rotates by a control signal applied from the control unit, and a cam 232 which is axially coupled to the motor 231 in a rotatable manner and of which the outer surface is in contact with the outer surface of the locking plate 220 to push and move the locking plate 220 toward the unit bracket 130 according to rotational angles.

It is preferable to use a stepping motor capable of setting rotational angles, as the motor 231. However, various other types of motors can also be applied.

The cam 232 has one or both surfaces which are curved, and is eccentrically coupled to a shaft of the motor 231 to apply power pushing the locking plate 220 toward the unit bracket 130 according to the rotational angles.

When the locking plate 220 moves toward the unit bracket 130 by the cam 232, the locking plate 220, which protrudes to one surface of the unit bracket 130, is inserted into the protrusion insertion hole 221 of the locking plate 220. As described above, when the locking plate 220 installed on the coupling bracket 140 is coupled to the locking protrusion 210 installed on the unit bracket 130, the unit bracket 130 can be fixed relative to the coupling bracket 140. When the locking protrusion 210 is inserted into the protrusion insertion hole 221 of the locking plate 220, an elastic ring 212 made of an elastic material like urethane can be attached to the outer surface of the locking protrusion 210.

In addition, a wear-resistant cover 222 can be provided on the surface of the locking plate 220 which is in contact with the cam 232. While the cover 222 can be separately made and then joined to the locking plate 220, the locking plate 220 can be made in a coating manner that wear-resistant resin is sprayed or impregnated on the outer surface of the locking plate 220.

In order to allow the locking plate 220 to be movably connected relative to the coupling bracket 140 and to ensure that the locking plate 220 moves accurately without twisting when pushed by the cam 232, a guide hole 227 is formed in the coupling bracket 140, and a guide pin 225, which is connected at one end to the locking plate 220, is slidably installed within the guide hole 227.

Moreover, the lower portion of the guide pin 225 is elastically supported by a return spring 226 so that, when the locking plate 220 does not receive a pushing force from the cam 232, the locking plate 220 automatically returns to its original position due to the elastic force of the return spring (226), so that the coupling between the locking plate 220 and the locking protrusion 210 can be released.

The locking unit having the above configuration can operate as follows.

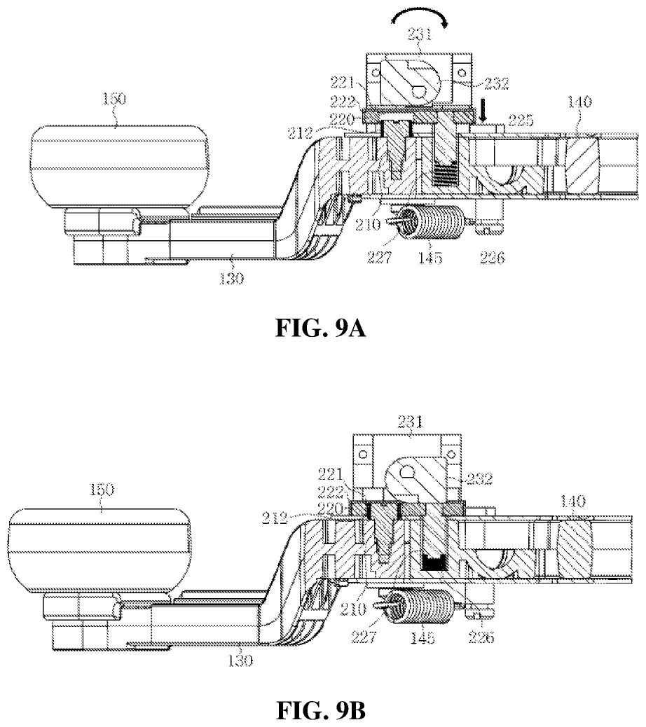

In order to obtain strong pressure by fixing the unit bracket 130 relative to the coupling bracket 140, as illustrated in FIG. 6(A), in a state where the unit bracket 130 does not receive a load by the user's body, the control unit 50 applies a control signal to the motor 231 to rotate the motor 231 by a certain amount. Accordingly, as illustrated in FIGS. 9A and 9B, the cam 232, which is eccentrically coupled to the shaft of the motor 231, rotates by a predetermined angle (for example, 180°).

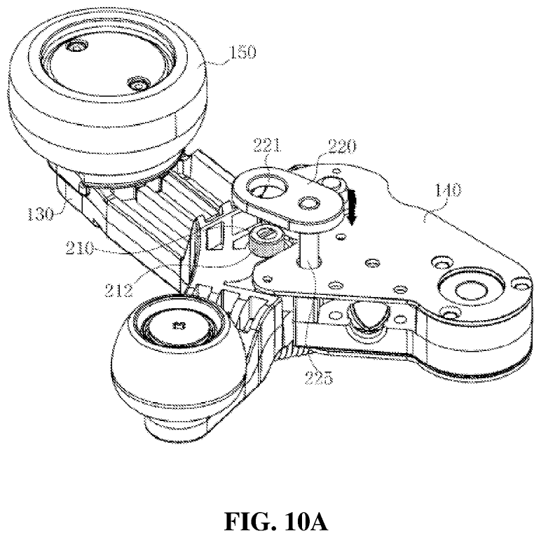

As the cam 232 rotates, the locking plate 220 is pushed and moves toward the unit bracket 130. As illustrated in FIGS. 9B and 10B, the locking protrusion 210 of the unit bracket 130 is inserted into the protrusion insertion hole 221 of the locking plate 220, and the unit bracket 130 is fixed relative to the coupling bracket 140.

In order to release the fixed state of the unit bracket 130 and the coupling bracket 140, a control signal is applied to the motor 231 from the control unit 50. The motor 231 rotates in the opposite direction to the previous direction or the same direction to rotate the cam 232 by 180º. When the cam 232 rotates 180°, the power pushing the locking plate 220 is removed from the cam 232, and the locking plate 220 returns to the original position by the elastic force of the return spring 226, so that the coupling between the locking plate 220 and the locking protrusion 210 is released. Therefore, the unit bracket 130 can rotate relative to the coupling bracket 140 around the hinge shaft 135.

In the first embodiment of the locking unit, the locking protrusion 210 is installed on the unit bracket 130, and the locking plate 220 and locking actuator are installed on the coupling bracket 140. However, in contrast, the locking protrusion 210 can be installed on the coupling bracket 140 and the locking plate 220 and locking actuator can be installed on the unit bracket 130.

Furthermore, in the first embodiment of the locking unit, the locking plate 220 is moved by the motor 231 and the cam 232 of the locking actuator to constrain the locking protrusion 210. However, in the second embodiment described below, a locking structure, such as a pin or protrusion, can be inserted into a hole formed in the coupling bracket 140 or the unit bracket 130 to fix the unit bracket 130 relative to the coupling bracket 140.

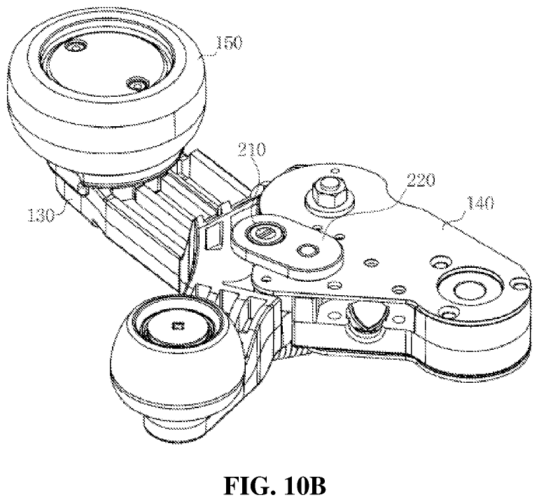

FIGS. 10 and 11 illustrate the second embodiment of the locking unit. The locking unit includes a locking pin 251 which is installed on the unit bracket 130 to be linearly movable and is inserted into a locking hole 250 formed in the coupling bracket 140, and a pin actuator which reciprocally moves the locking pin 251 within a range of a predetermined distance according to a control signal supplied from the control unit 50.

In this embodiment, the pin actuator may be a solenoid-type actuator 260 which generates an electric field by the control signal supplied from the control unit to linearly move the locking pin within a range of the predetermined distance.

As described above, the locking pin 251 and the solenoid-type actuator 260 are installed on the unit bracket 130, and the locking hole 250 is formed in the coupling bracket 140. However, conversely, the locking pin 251 and the solenoid-type actuator 260 can be installed on the coupling bracket 140, and the locking hole 250 can be formed in the unit bracket 130.

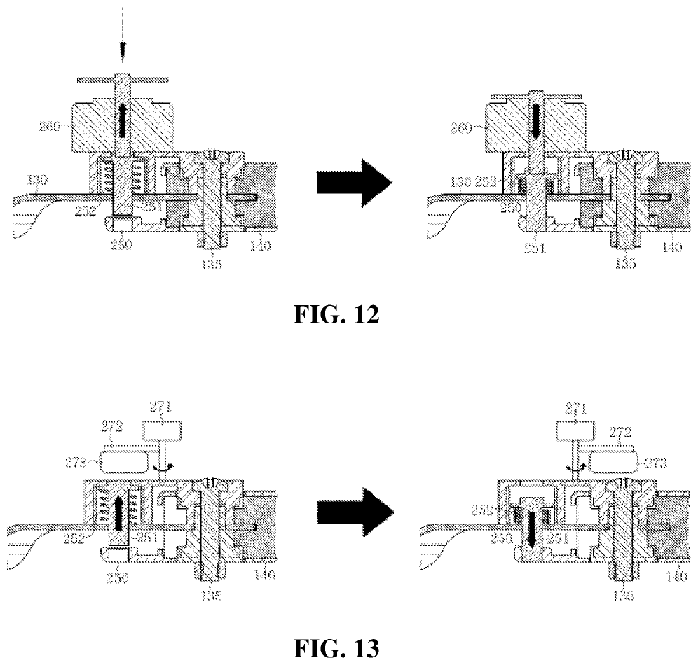

Moreover, as illustrated in FIG. 13, the pin actuator which moves the locking pin 251 may include a motor 271 which rotates by the control signal from the control unit, a rotary member 272 which rotates by being shaft-coupled to the motor 271, a pin operating member 273 which linearly reciprocates the locking pin 251 according to the rotational angle of the rotary member 272, and a return spring 252 which elastically supports the locking pin 251 in a direction to separate the locking pin 251 from the locking hole 250.

If the locking pin 251 is made of a ferromagnetic metal, the pin operating member 273 may be a magnet which moves the locking pin 251 by magnetic force.

Additionally, without using the magnet as the pin operating member 273, the cam 232 illustrated in FIGS. 8 and 9 can be applied as the pin operating member 273 to move the locking pin 251.

Besides the above, the locking unit may be configured by appropriately combining the configurations of the locking units described in the various embodiments.

As described above, when the unit bracket 130 is in a specific state relative to the coupling bracket 140, especially when the unit bracket 130 is in the initial state that the user's load is not applied to the unit bracket 130 and only the elastic force of the elastic member 145 is applied to the unit bracket 130 (see FIG. 6(A)), the control signal can be applied from the control unit 50 to the locking unit to fix the unit bracket 130 relative to the coupling bracket 140. In this state, when the massage module 100 moves to massage the user's body, since the unit bracket 130 is fixed relative to the coupling bracket 140, strong pressure can be provided.

On the other hand, when the locking unit releases the fixed state between the unit bracket 130 and the coupling bracket 140, since the unit bracket 130 becomes elastically movable relative to the coupling bracket 140, gentle pressure can be provided.

In the above-described embodiment, it is proposed that the unit bracket 130 can be fixed at a single position relative to the coupling bracket 140 by the locking unit. However, the plurality of locking protrusions 210 or locking holes 250 may be formed on the unit bracket 130 or the coupling bracket 140 to fix the unit bracket 130 to the coupling bracket 140 at a plurality of positions, thereby providing various pressing forces.

In addition, when the module base 110 of the massage module 100 moves to a specific location of the massage device 1 where no load from the user's body is applied to the sample member 150, the control unit 50 can apply the control signal to the locking unit to fix or release the unit bracket 130 relative to the coupling bracket 140. For example, when the module base 110 of the massage module 100 moves to the top of the massage device 1 and is located above the user's shoulder, the control unit 50 can apply the control signal to the locking unit to fix the unit bracket 130 relative to the coupling bracket 140.

Alternatively, a position detection sensor, such as a hall sensor, which detects the rotational position of the unit bracket 130 relative to the coupling bracket 140 can be added. According to the rotational position of the unit bracket 130 detected by the position detection sensor, the control unit 50 of the massage device 1 can apply the control signal to the locking unit to fix or release the unit bracket 130 relative to the coupling bracket 140.

Various embodiments have been described so far. One of ordinary skill in the art will understand that the invention can be implemented in modified forms without departing from the essential characteristics of the invention. Therefore, the described embodiments should be considered in an illustrative rather than a restrictive sense. The scope of the invention is defined by the appended claims, and all differences within that scope should be interpreted as being included in the invention.

1. A hybrid massage module of a massage device comprising:
a module base installed in the massage device;
an actuator installed on the module base, and providing at least one of powers for vibration, linear motion, rotational motion, and position adjustment for body massage;
a coupling bracket connected to the actuator to transmit the power of the actuator;
a unit bracket installed on the coupling bracket to be rotatable around a hinge shaft;
an elastic member supporting the unit bracket elastically relative to the coupling bracket;
a sample member rotatably installed on the unit bracket, applying pressure to a user's body part while rolling; and
a locking unit which, based on a control signal applied from the control unit of the massage device, fixes or releases the unit bracket relative to the coupling bracket.

2. The hybrid massage module according to claim 1, wherein the locking unit comprises: a locking protrusion formed to protrude from one surface of the unit bracket or the coupling bracket, a locking plate which is movably installed on the coupling bracket or the unit bracket and has a protrusion insertion hole into which the locking protrusion is inserted, and a locking actuator which is installed on the coupling bracket or the unit bracket to reciprocally move the locking plate toward the locking protrusion within a range of a predetermined distance by a control signal supplied from the control unit 50 of the massage device.

3. The hybrid massage module according to claim 2, wherein the locking actuator includes: a motor which rotates by a control signal applied from the control unit, and a cam which is axially coupled to the motor in a rotatable manner and of which the outer surface is in contact with the outer surface of the locking plate to push and move the locking plate toward the unit bracket according to rotational angles.

4. The hybrid massage module according to claim 3, wherein a wear-resistant material cover is provided on the surface of the locking plate which is in contact with the cam.

5. The hybrid massage module according to claim 2, further comprising: a return spring which elastically supports the locking plate relative to the coupling bracket or the unit bracket.

6. The hybrid massage module according to claim 2, wherein a guide hole is formed in the coupling bracket or the unit bracket, and a guide pin is provided in the guide hole to guide the movement of the locking plate relative to the coupling bracket or the unit bracket due to one end portion of the guide pin which is coupled to the locking plate to connect the locking plate.

7. The hybrid massage module according to claim 1, wherein the locking unit comprises a locking pin which is installed on the coupling bracket or the unit bracket to be linearly movable and is inserted into a locking hole formed in the unit bracket or the coupling bracket, and a pin actuator which reciprocally moves the locking pin within a range of a predetermined distance according to a control signal supplied from the control unit.

8. The hybrid massage module according to claim 7, wherein the pin actuator is a solenoid-type actuator which generates an electric field by the control signal applied from the control unit to linearly move the locking pin within a range of a predetermined distance.

9. The hybrid massage module according to claim 7, wherein the pin actuator includes a motor which rotates by the control signal from the control unit, a rotary member which rotates by being shaft-coupled to the motor, a pin operating member which linearly reciprocates the locking pin according to the rotational angle of the rotary member, and a return spring which elastically supports the locking pin in a direction to separate the locking pin from the locking hole.

10. The hybrid massage module according to claim 9, wherein the pin operating member is a cam which is in close contact with one end of the locking pin and applies a pushing force to the locking pin according to the rotational angle to move the locking pin.

11. The hybrid massage module according to claim 9, wherein the pin operating member is a magnet which moves the locking pin by magnetic force.

12. The hybrid massage module according to claim 1, wherein the locking unit selectively fixes the unit bracket relative to the coupling bracket at a plurality of positions.

13. The hybrid massage module according to claim 1, further comprising: a position detection sensor which detects the rotational position of the unit bracket relative to the coupling bracket, wherein the control unit of the massage device applies a control signal to the locking unit according to the detected rotational position of the unit bracket to fix or release the unit bracket relative to the coupling bracket.

14. The hybrid massage module according to claim 1, wherein when the module base moves to a specific location of the massage device where no load from the user's body is applied to the sample member, the control unit of the massage device applies the control signal to the locking unit to fix or release the unit bracket relative to the coupling bracket.

15. The hybrid massage module according to claim 3, wherein a guide hole is formed in the coupling bracket or the unit bracket, and a guide pin is provided in the guide hole to guide the movement of the locking plate relative to the coupling bracket or the unit bracket due to one end portion of the guide pin which is coupled to the locking plate to connect the locking plate.

16. The hybrid massage module according to claim 4, wherein a guide hole is formed in the coupling bracket or the unit bracket, and a guide pin is provided in the guide hole to guide the movement of the locking plate relative to the coupling bracket or the unit bracket due to one end portion of the guide pin which is coupled to the locking plate to connect the locking plate.

17. The hybrid massage module according to claim 5, wherein a guide hole is formed in the coupling bracket or the unit bracket, and a guide pin is provided in the guide hole to guide the movement of the locking plate relative to the coupling bracket or the unit bracket due to one end portion of the guide pin which is coupled to the locking plate to connect the locking plate.
